(19) United States
(12) Patent Application Publication
(10) Pub. No.: US 2024/0224241 A1
(43) Pub. Date: Jul. 4, 2024

(54) DEMODULATION REFERENCE SIGNAL (DMRS) PATTERNS HAVING DIFFERENT DMRS DENSITIES

(71) Applicant: QUALCOMM Incorporated, San Diego, CA (US)

(72) Inventors: Xiaoxia ZHANG, San Diego, CA (US); Sarath PINAYOUR CHANDRASEKARAN, Hyderabad (IN); Satish KUMAR, Hyderabad (IN)

(21) Appl. No.: 18/148,613

(22) Filed: Dec. 30, 2022

(51) Int. Cl. H04W 72/0446; H04L 5/00; H04W 72/23

(52) U.S. Cl. CPC H04W 72/0446; H04L 5/0051; H04W 72/23

(57) ABSTRACT

Various aspects of the present disclosure generally relate to wireless communication. In some aspects, a user equipment (UE) may transmit, to a network node, an uplink transmission in an uplink slot, the uplink slot being associated with a first demodulation reference signal (DMRS) pattern having a first DMRS density. The UE may receive, from the network node, a downlink transmission in a downlink slot, the downlink slot being associated with a second DMRS pattern having a second DMRS density. Numerous other aspects are described.

### FIELD OF THE DISCLOSURE

Aspects of the present disclosure generally relate to wireless communication and to techniques and apparatuses for demodulation reference signal (DMRS) patterns having different DMRS densities.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

In some implementations, an apparatus for wireless communication at a user equipment (UE) includes a memory and one or more processors, coupled to the memory, configured to: transmit, to a network node, an uplink transmission in an uplink slot, the uplink slot being associated with a first demodulation reference signal (DMRS) pattern having a first DMRS density; and receive, from the network node, a downlink transmission in a downlink slot, the downlink slot being associated with a second DMRS pattern having a second DMRS density.

In some implementations, an apparatus for wireless communication at a network node includes a memory and one or more processors, coupled to the memory, configured to: receive, from a UE, an uplink transmission in an uplink slot, the uplink slot being associated with a first DMRS pattern having a first DMRS density; and transmit, to the UE, a downlink transmission in a downlink slot, the downlink slot being associated with a second DMRS pattern having a second DMRS density.

In some implementations, a method of wireless communication performed by a UE includes transmitting, to a network node, an uplink transmission in an uplink slot, the uplink slot being associated with a first DMRS pattern having a first DMRS density; and receiving, from the network node, a downlink transmission in a downlink slot, the downlink slot being associated with a second DMRS pattern having a second DMRS density.

In some implementations, a method of wireless communication performed by a network node includes receiving, from a UE, an uplink transmission in an uplink slot, the uplink slot being associated with a first DMRS pattern having a first DMRS density; and transmitting, to the UE, a downlink transmission in a downlink slot that occurs after the uplink slot, the downlink slot being associated with a second DMRS pattern having a second DMRS density.

In some implementations, a non-transitory computer-readable medium storing a set of instructions for wireless communication includes one or more instructions that, when executed by one or more processors of a UE, cause the UE to: transmit, to a network node, an uplink transmission in an uplink slot, the uplink slot being associated with a first DMRS pattern having a first DMRS density; and receive, from the network node, a downlink transmission in a downlink slot, the downlink slot being associated with a second DMRS pattern having a second DMRS density.

In some implementations, a non-transitory computer-readable medium storing a set of instructions for wireless communication includes one or more instructions that, when executed by one or more processors of a network node, cause the network node to: receive, from a UE, an uplink transmission in an uplink slot, the uplink slot being associated with a first DMRS pattern having a first DMRS density; and transmit, to the UE, a downlink transmission in a downlink slot that occurs after the uplink slot, the downlink slot being associated with a second DMRS pattern having a second DMRS density.

In some implementations, an apparatus for wireless communication includes means for transmitting, to a network node, an uplink transmission in an uplink slot, the uplink slot being associated with a first DMRS pattern having a first DMRS density; and means for receiving, from the network node, a downlink transmission in a downlink slot, the downlink slot being associated with a second DMRS pattern having a second DMRS density.

In some implementations, an apparatus for wireless communication includes means for receiving, from a UE, an uplink transmission in an uplink slot, the uplink slot being associated with a first DMRS pattern having a first DMRS density; and means for transmitting, to the UE, a downlink transmission in a downlink slot that occurs after the uplink slot, the downlink slot being associated with a second DMRS pattern having a second DMRS density.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIGS. 4-6 are diagrams illustrating examples associated with demodulation reference signal (DMRS) patterns having different DMRS densities, in accordance with the present disclosure.

FIGS. 7-8 are diagrams illustrating example processes associated with DMRS patterns having different DMRS densities, in accordance with the present disclosure.

FIGS. 9-10 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

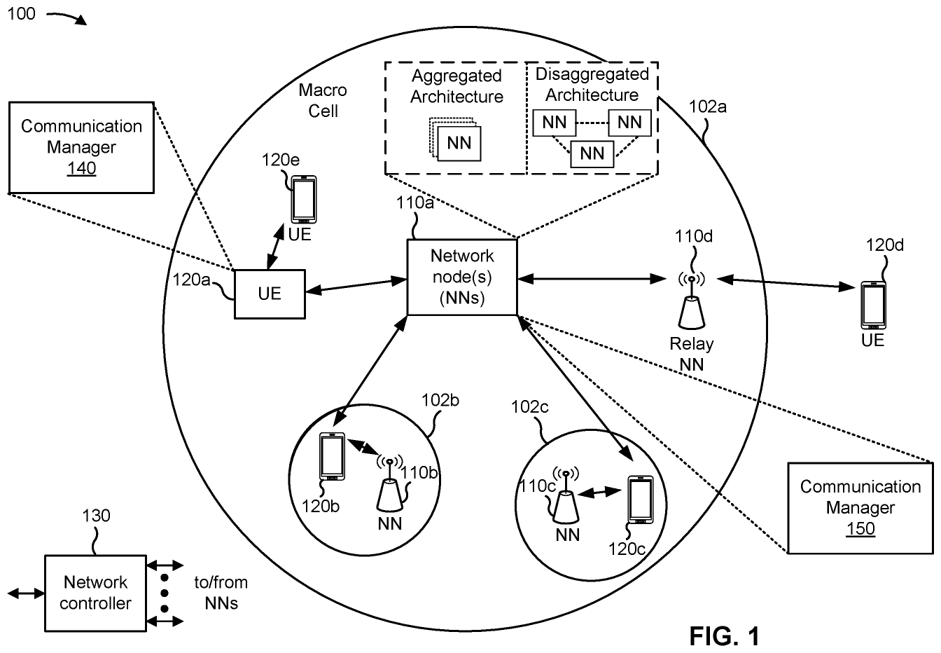

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IOT) devices, or may be implemented as NB-IOT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With these examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a UE (e.g., UE 120) may include a communication manager 140. As described in more detail elsewhere herein, the communication manager 140 may transmit, to a network node, an uplink transmission in an uplink slot, the uplink slot being associated with a first demodulation reference signal (DMRS) pattern having a first DMRS density; and receive, from the network node, a downlink transmission in a downlink slot, the downlink slot being associated with a second DMRS pattern having a second DMRS density. Additionally, or alternatively, the communication manager 140 may perform one or more other operations described herein.

In some aspects, a network node (e.g., network node 110) may include a communication manager 150. As described in more detail elsewhere herein, the communication manager 150 may receive, from a UE, an uplink transmission in an uplink slot, the uplink slot being associated with a first DMRS pattern having a first DMRS density; and transmit, to the UE, a downlink transmission in a downlink slot that occurs after the uplink slot, the downlink slot being associated with a second DMRS pattern having a second DMRS density. Additionally, or alternatively, the communication manager 150 may perform one or more other operations described herein.

As indicated above, FIG. 1 is provided as an example. Other examples may differ from what is described with regard to FIG. 1.

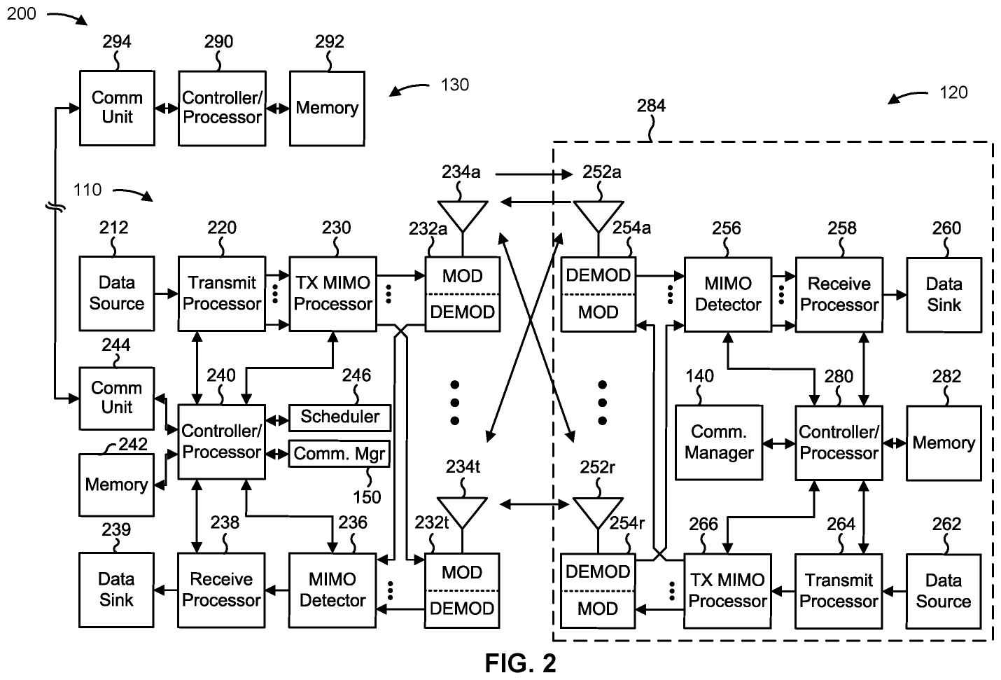

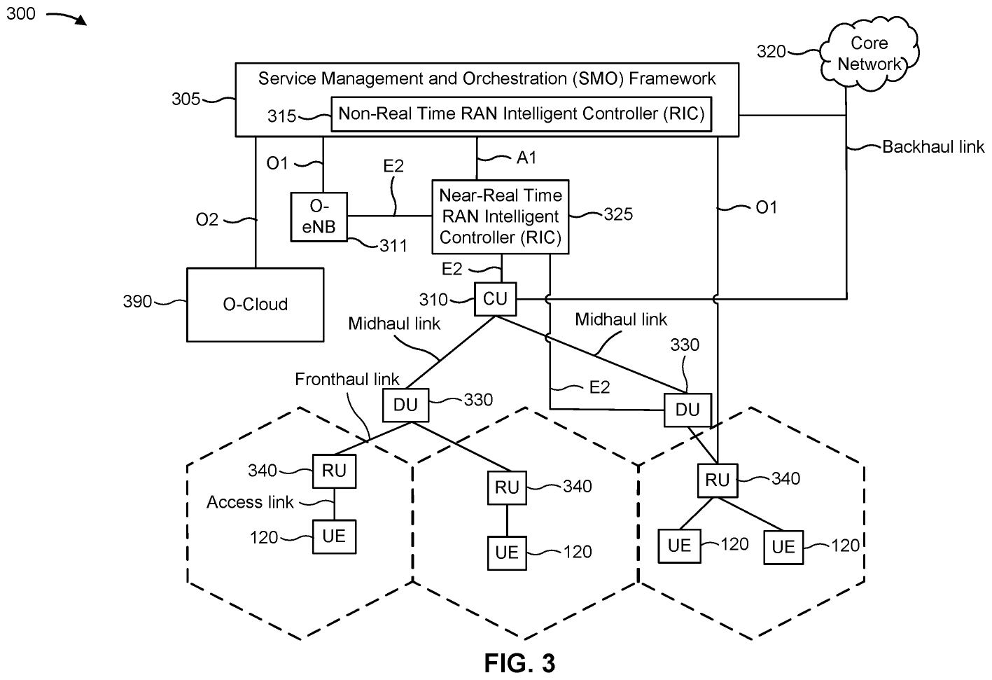

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a DMRS) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

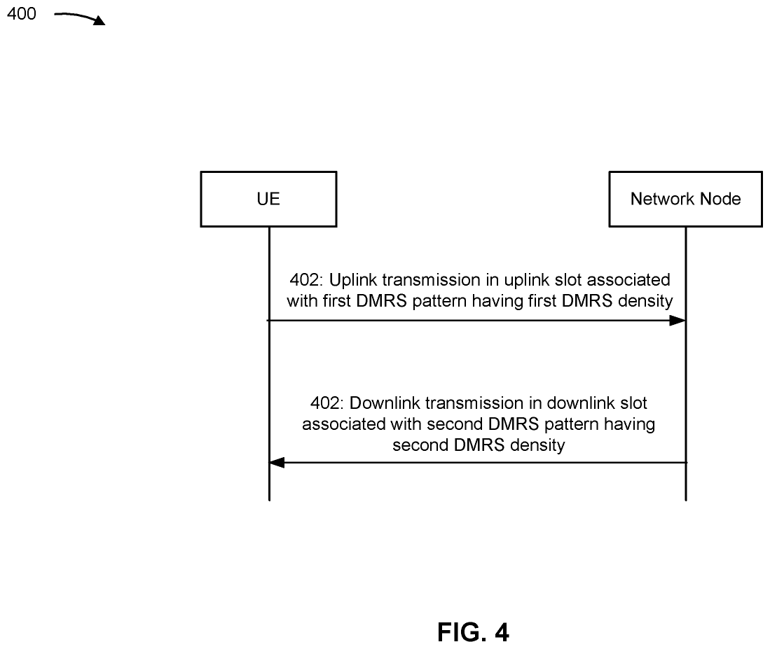

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 4-10).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 4-10).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

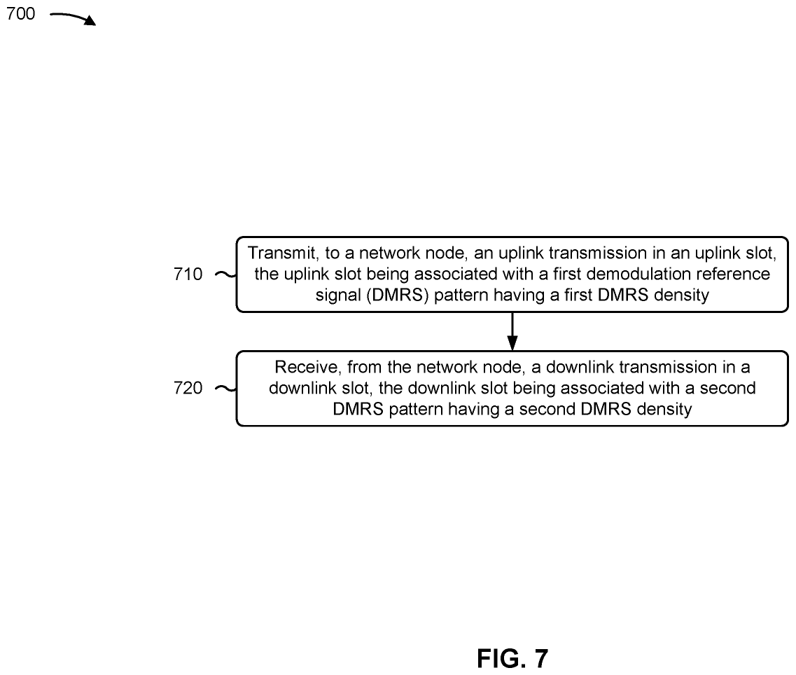

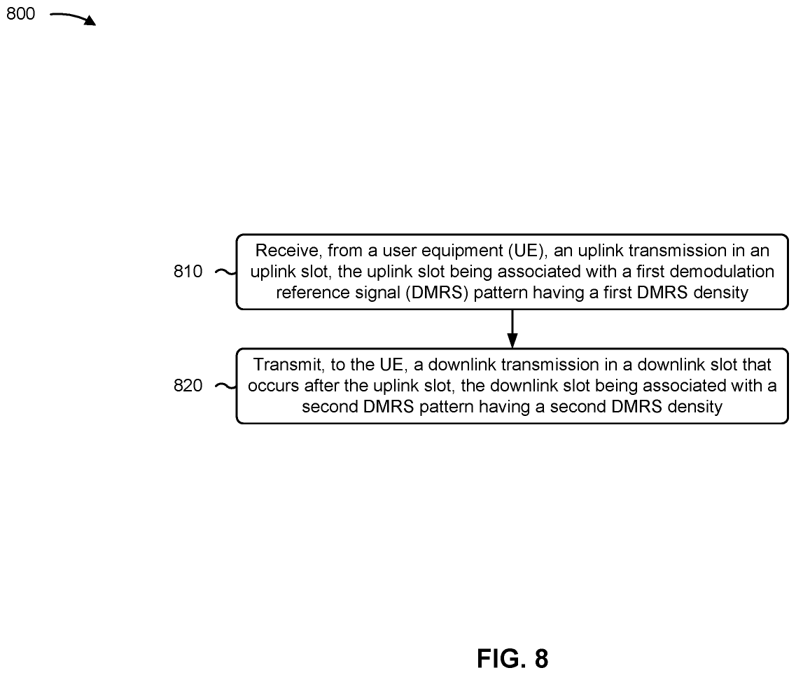

The controller/processor 240 of the network node 110, the controller/processor 280 of the UE 120, or any other component(s) of FIG. 2 may perform one or more techniques associated with DMRS patterns having different DMRS densities, as described in more detail elsewhere herein. For example, the controller/processor 240 of the network node 110, the controller/processor 280 of the UE 120, or any other component(s) (or combinations of components) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a UE (e.g., UE 120) includes means for transmitting, to a network node, an uplink transmission in an uplink slot, the uplink slot being associated with a first DMRS pattern having a first DMRS density; and/or means for receiving, from the network node, a downlink transmission in a downlink slot, the downlink slot being associated with a second DMRS pattern having a second DMRS density. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., network node 110) includes means for receiving, from a UE, an uplink transmission in an uplink slot, the uplink slot being associated with a first DMRS pattern having a first DMRS density; and/or means for transmitting, to the UE, a downlink transmission in a downlink slot that occurs after the uplink slot, the downlink slot being associated with a second DMRS pattern having a second DMRS density. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

A physical downlink shared channel (PDSCH) may be associated with certain configuration. For example, the PDSCH may be associated with a time division duplexing (TDD) configuration having a “DDDSU” pattern, where “D” refers to a downlink slot, “S” refers to a special slot, and “U” refers to an uplink slot. The TDD configuration may be associated with a special slot configuration, which may include ten downlink slots, two special slots, and two uplink slots. A slot may include 14 symbols (e.g., symbol #1-symbol #14). A downlink slot may have a physical downlink control channel (PDCCH) in symbol #1, and a PDSCH in symbol #2 to symbol #13. A special slot may have a PDCCH in symbol #1, and a PDSCH in symbol #2 to symbol #9. The special slot may also have a physical uplink control channel (PUCCH) for hybrid automatic repeat request (HARQ) feedback. An uplink slot may have a physical uplink shared channel (PUSCH) when uplink data and the PUCCH for HARQ feedback are present. The PDSCH may be associated with an MCS table used in a downlink (e.g., Table-1). An MCS index of 27 may be selected from the MCS table. The PDSCH may be associated with a DMRS Type A position 2 and an additional DMRS position (e.g., Position 1). A phase tracking reference signal (PTRS) may not be enabled.

A decode issue may occur for the PDSCH associated with the certain configuration. The decode issue may occur in a first downlink slot in the TDD configuration, where the first downlink slot is immediately after an uplink slot. The decode issue may involve a block error rate (BLER) that satisfies a threshold (e.g., a 5-10% BLER). In other words, the first downlink slot immediately after the uplink slot may be associated with the BLER that satisfies the threshold, thereby degrading a system performance. Other slots in the TDD configuration (e.g., slots other than the first downlink sot immediately after the uplink slot) may not be associated with a BLER that satisfies the threshold. That is, the BLER in the first downlink slot immediately after the uplink slot may be higher than the BLER in the other slots in the TDD configuration. The decode issue may be due to a discontinuity observed by the UE, which may negatively impact an accuracy of a phase estimation at the UE. The UE may observe the discontinuity and may need to switch beams (e.g., switch from a receive beam to a transmit beam), which may impact the UE when decoding the first downlink slot after the uplink slot.

In some examples, the decode issue may be observed in higher frequency bands (e.g., a 39 GHz band), but may or may not be observed in lower frequency bands (e.g., a 28 GHz band). In other examples, in the lower frequency bands, when using a certain MCS table (e.g., Table-2) with a relatively high MCS index corresponding to 256 quadrature amplitude modulation (QAM), the decode issue may be observed.

In various aspects of techniques and apparatuses described herein, a UE may transmit, to a network node, an uplink transmission in an uplink slot. The uplink slot may be associated with a first DMRS pattern having a first DMRS density. The UE may receive, from the network node, a downlink transmission in a downlink slot. The downlink slot may be associated with a second DMRS pattern having a second DMRS density. In some aspects, the downlink slot may occur after the uplink slot, and the second DMRS density may be higher than the first DMRS density. In other words, the downlink slot may be a first downlink slot after the uplink slot, and the downlink slot may have a higher DMRS density as compared to the uplink slot. In some aspects, the uplink slot may occur after the downlink slot, and the first DMRS density may be higher than the second DMRS density. In other words, the uplink slot may be a first uplink slot after the downlink slot, and the uplink slot may have a higher DMRS density as compared to the downlink slot.

In some aspects, different DMRS patterns having different DMRS densities may be applied for different slots or repetitions. The different DMRS patterns may be applied across the different slots or repetitions. A DMRS pattern with a relatively high DMRS density may be enabled for relatively high bands (e.g., a 39 GHz band operation), which may resolve a decode issue associated with the downlink slot immediately after the uplink slot, where the downlink slot may otherwise be associated with a BLER that satisfies a threshold. By reducing the BLER due to using the DMRS pattern with the relatively high DMRS density, a system performance may be improved. The DMRS pattern with the relatively high DMRS density may resolve the decode issue when a certain MCS index (e.g., an MCS index of 27) is used. The DMRS pattern with the relatively high DMRS density may be used for the downlink slots after the UE switches from uplink transmission to downlink reception, but may not be used for other slot types, which would unnecessarily increase a system overhead. In other words, the DMRS pattern with the relatively high DMRS density may not be used for any slots other than the downlink slot immediately following the uplink slot. Alternatively, or additionally, the DMRS pattern with the relatively high DMRS density may be used for the uplink slot after the UE switches from downlink reception to uplink transmission, but may not be used for other slot types, which would unnecessarily increase a system overhead. In other words, the DMRS pattern with the relatively high DMRS density may not be used for any slots other than the uplink slot immediately following the downlink slot. The DMRS pattern with the relatively high density may be configured based at least in part on UE feedback, as the UE may be able to determine information regarding an amount of time needed to stabilize on a downlink slot or an uplink slot after a transmit/receive switching.

FIG. 4 is a diagram illustrating an example 400 associated with DMRS patterns having different DMRS densities, in accordance with the present disclosure. As shown in FIG. 4, example 400 includes communication between a UE (e.g., UE 120) and a network node (e.g., network node 110). In some aspects, the UE and the network node may be included in a wireless network, such as wireless network 100.

As shown by reference number 402, the UE may transmit, to the network node, an uplink transmission in an uplink slot. The uplink slot may be associated with a first DMRS pattern having a first DMRS density. The first DMRS density may refer to an amount of resources for a DMRS in the uplink slot. The uplink transmission may be a PUSCH transmission.

As shown by reference number 404, the UE may receive, from the network node, a downlink transmission in a downlink slot. The downlink slot may be associated with a second DMRS pattern having a second DMRS density. The second DMRS density may refer to an amount of resources for a DMRS in the downlink slot. The downlink transmission may be a PDSCH transmission.

In some aspects, the downlink slot may occur after the uplink slot. For example, the downlink slot may occur immediately after the uplink slot. The downlink slot may be a first downlink slot after the uplink slot. The second DMRS density may be higher than the first DMRS density. In other words, the downlink slot may be associated with a higher DMRS density as compared to the uplink slot. The second DMRS pattern having the second DMRS density may be associated with the high DMRS density.

In some aspects, a high DMRS density may be enabled in the downlink slot, which may be after the uplink slot, and a normal DMRS density (or a default DMRS density) may be associated with remaining slots. The normal DMRS density may be associated with a lower DMRS density as compared to the high DMRS density. In some aspects, the high DMRS density may be enabled in the downlink slot, which may be after a gap symbol or after an uplink symbol, while the remaining slots may be associated with the normal DMRS density. The high DMRS density may be defined for the downlink slot, which may occur after a discontinuity (e.g., a discontinuity based at least in part on a transition from the uplink slot to the downlink slot), and the normal DMRS density may be associated with the remaining slots (e.g., including the uplink slot). A downlink transmission may experience a phase discontinuity issue on the downlink slot, so the downlink slot may be associated with the high DMRS density.

In some aspects, the uplink slot may occur after the downlink slot. The uplink slot may occur immediately after the downlink slot. Alternatively, the uplink slot may occur immediately after a special slot, where the special slot may occur immediately after the downlink slot. The first DMRS density may be higher than the second DMRS density. In other words, the uplink slot may be associated with a higher DMRS density as compared to the downlink slot. The first DMRS pattern having the first DMRS density may be associated with the high DMRS density.

In some aspects, the high DMRS density may be enabled in the uplink slot, which may be after the downlink slot, and the normal DMRS density (or a default DMRS density) may be associated with the remaining slots (e.g., including the downlink slot). The normal DMRS density may be associated with the lower DMRS density as compared to the high DMRS density. In some aspects, the high DMRS density may be enabled in the uplink slot, which may be after a gap symbol or after a downlink symbol, while the remaining slots may be associated with the normal DMRS density. The high DMRS density may be defined for the uplink slot, which may occur after a discontinuity (e.g., a discontinuity based at least in part on a transition from the downlink slot to the uplink slot), and the normal DMRS density may be associated with the remaining slots. An uplink transmission may experience a phase discontinuity issue on the uplink slot (e.g., an uplink slot after the downlink slot or a symbol gap), so the uplink slot may be associated with the high DMRS density.

In some aspects, the UE may transmit, to the network node, an indication of a DMRS pattern index. The DMRS pattern index may be associated with the first DMRS pattern or the second DMRS pattern. The UE may select the DMRS pattern index from a list of DMRS pattern indexes. In some aspects, the UE may transmit, to the network node, a recommendation involving a DMRS pattern for a slot (e.g., the downlink slot or the uplink slot). The network node, based at least in part on the recommendation received from the UE, may configure the DMRS pattern (or another DMRS pattern) for the slot. In some aspects, the network node may configure an enumerated list of DMRS patterns, where each DMRS pattern may be associated with a specific DMRS density. The network node may configure the enumerated list of DMRS patterns based at least in part on the recommendation received from the UE. The UE may dynamically signal an indication of a selected DMRS pattern index, from the enumerated list of DMRS patterns, using a MAC control element (MAC-CE) over a PUSCH.

In some aspects, the UE may transmit, to the network node, an indication of a phase discontinuity associated with the downlink slot or the uplink slot. The UE may receive, from the network node and based at least in part on the indication, a configuration of multiple DMRS patterns with different additional positions and slot offsets. The multiple DMRS patterns may include the first DMRS pattern and the second DMRS pattern. In some aspects, the UE may indicate, to the network node, whether the UE has a phase continuity issue in the downlink slot or in the uplink slot, such that the network node may configure a high DMRS density in the downlink slot or in the uplink slot based at least in part on the UE indication. The network node may configure, via RRC signaling, the multiple DMRS patterns with the different additional positions and the slot offsets. In some aspects, the network node may transmit, to the UE via RRC signaling, different rules for resetting a DMRS density for a specific slot, and/or enabling a particular DMRS density on a specific slot.

In some aspects, a special slot (or flexible slot) may be associated with a third DMRS pattern having a third DMRS density. The special slot may be associated with a different DMRS pattern and associated DMRS density, as compared to the downlink slot and the uplink slot. In some aspects, for the special slot (or symbols), in which a downlink direction or an uplink direction is not configured via RRC signaling, a different DMRS density may be defined. The different DMRS density may depend on a downlink-uplink switching, which may be defined by a semi-static TDD pattern, a slot format indication (SFI), and/or a dynamic grant. Alternatively, to avoid a case in which the UE may miss the SFI or the dynamic grant and then become out-of-sync with the network node for a DMRS pattern, the different DMRS density may only be applicable to a downlink-uplink slot after a switching. The switching may be based at least in part on the semi-static TDD pattern, which may be configured via RRC signaling.

In some aspects, different DMRS patterns having different DMRS densities may be defined for different frequency ranges, different bands, different subcarrier spacings (SCSs), and/or different MCSs. A different DMRS density (e.g., a denser DMRS pattern) may be applicable for a different frequency range, band, SCS, and/or MCS. For example, the different DMRS density may be more useful for a 39 GHz band, as compared to a 28 GHz band. A different DMRS density may be SCS or MCS dependent. A higher MCS and a larger SCS, as compared to a lower MCS and a smaller SCS, may be more sensitive to a stability after a transmit/receive switching. The different DMRS density may be more effective for higher bands, such as FR2-2 bands, FR4 bands (e.g., 71-114 GHZ), sub-terahertz (sub-THz) bands, or THz bands, for which an RF impairment is expected to be more severe with a higher center frequency, as compared to lower bands.

In some aspects, in a coverage enhancement scenario, a transmission may run for multiple slots. When a decoding remains unsuccessful, even after a significant number of repetitions, increasing a DMRS density for subsequent repetitions may improve a channel estimation, and thus a likelihood of a successful decoding. The channel estimation may depend on a UE's hardware and software capabilities, so recommendations from the UE regarding a DMRS density may be considered in such cases. In some aspects, the UE may dynamically or statically signal, to the network node, an indication of a preferred DMRS density or a request to change to the preferred DMRS density during an ongoing multi-slot repetitions-based transmission. In addition to a dynamic indication or request from the UE regarding the preferred DMRS density, different DMRS patterns with associated DMRS densities may be needed for different slots. The different DMRS patterns may be configured based at least in part on a UE recommendation, as the UE may possess information regarding an amount of time needed to stabilize on a downlink slot or an uplink slot.

In some aspects, the downlink transmission may be one of multiple repetitions associated with a multi-slot and repetition-based transmission. In some aspects, the UE may transmit, to the network node, a request for a preferred DMRS pattern having a preferred DMRS density during the multi-slot and repetition-based transmission. The request may be based at least in part on a metric associated with the multi-slot and repetition-based transmission. The UE may receive, from the network node and based at least in part on the request being granted, an indication of a new DMRS pattern having a new DMRS density. The new DMRS pattern may or may not correspond to the preferred DMRS pattern. The UE may receive the indication in downlink control information (DCI) via a PDCCH. The PDCCH may be rate matched on PDSCH resources intended for the UE. In some aspects, the network node may signal the new DMRS pattern as part of the DCI transmitted on the PDCCH. The PDCCH may be rate matched on the PDSCH resources (e.g., resource blocks and/or symbols) intended for the same UE. By rate matching the PDCCH on the PDSCH resources, other symbols may not be affected, and the signaling may only be sent to the intended UE (e.g., other UEs may not have to perform blind decoding).

In some aspects, the UE may receive, from the network node, an indication of a new DMRS pattern having a new DMRS density, where the indication may be based at least in part on a metric associated with the multi-slot and repetition-based transmission. The new DMRS pattern may be indicated via a mapping to a random sequence of a plurality of random sequences. A PDSCH DMRS or data signal may be scrambled with the random sequence. Multiple hypotheses of de-scrambling may be based at least in part on the plurality of random sequences. In other words, the network node may scramble the PDSCH DMRS or data signals with any one of the random sequences, and the UE may not be aware of which random sequence was used by the network node. The UE may need to perform multiple hypothesis of de-scrambling using all configured random sequences, and only one of the random sequences may give a successful PDSCH decoding, thereby also indicating the DMRS pattern (e.g., the new DMRS pattern having the new DMRS density) to use for future downlink slots. A blind detection by the UE may be performed after a number of repetitions, which may serve to balance a blind detection overhead and flexibility of a DMRS pattern change.

In some aspects, the network node may signal the new DMRS pattern by mapping the new DMRS pattern to different random sequences. The network node may signal the new DMRS pattern as the static configuration over the RRC signaling or dynamically over the PDSCH MAC-CE. For example, DMRS pattern #0 may be associated with random sequence #0, DMRS pattern #1 may be associated with random sequence #1, DMRS pattern #2 may be associated with random sequence #2, DMRS pattern #3 may be associated with random sequence #3, and DMRS pattern #N may be associated with random sequence #N. The network node may scramble the PDSCH DMRS/data signals with any one of the random sequences, and the UE may not be aware of which random sequence was used by the network node. The UE may need to perform multiple hypotheses of random sequences, and only one of the random sequences may give a successful PDSCH decoding, thereby also indicating the new DMRS pattern to use for future downlink slots.

In some aspects, the indication may indicate a downlink slot offset and a number of slots for which the new DMRS pattern having the new DMRS density is valid. In some aspects, the indication may be received as a static configuration over RRC signaling or the indication may be received dynamically over a PDSCH MAC-CE. The network node may indicate, to the UE, the future downlink slot and the number of slots for which the new DMRS pattern is to be valid using DCI or the PDSCH MAC-CE.

In some aspects, a UE-initiated request of the preferred DMRS density may be transmitted to the network node. The network node may indicate, to the UE, a DMRS pattern change in the middle of repetitions. In some aspects, the UE may be scheduled with a PDSCH with multiple repetitions (e.g., X repetitions). The UE may be scheduled with PUCCH resources for providing interim HARQ feedback. A PDSCH decoding may fail at the UE after N repetitions, where Nis less than X. The UE may identify a poor channel estimation based at least in part on predefined metrics. The predefined metrics may include a signal-to-noise ratio (SNR), an RSRP measurement, an RSSI measurement, and/or a Doppler estimate. The UE may recommend a new DMRS density (e.g., using two bits) to the network node over a PUCCH, along with a HARQ feedback. The HARQ feedback may be a negative acknowledgement (NACK), which may be based at least in part on the PDSCH decoding failure.

In some aspects, the UE may transmit a request with the recommendation for the new DMRS density. The network node may decode the UE's request, and the network node may signal a change of DMRS density to the UE. The network node may signal the change of DMRS density using a downlink piggyback DCI, which may be rate matched around data but may not affect a payload. Alternatively, the network node may signal the change of DMRS density using different DMRS sequences. The network node may use the different DMRS sequences to signal different DMRS patterns. For example, two DMRS patterns may be configured via RRC signaling. A first DMRS pattern may be associated with a first random sequence, and a second DMRS pattern may be associated with a second random sequence. The UE may need to perform a blind detection, which may result in a relatively high processing overhead. In some aspects, the network node may detect a need to change a current DMRS density over a PUSCH, and the network node may indicate a new DMRS density to the UE over an uplink DCI. In other words, the network node may detect the need to change the current DMRS density, instead of the network node receiving the request from the UE.

In some aspects, dynamically or statically indicating the preferred DMRS density during the ongoing multi-slot repetitions-based transmission may involve balancing blind detection and DCI overhead with flexibility of DMRS pattern changes. When using a DMRS sequence, the UE may need to perform blind detection. When using a downlink piggyback DCI, an associated overhead may be present in a PDSCH transmission. The blind detection and the DCI overhead may be controlled by implementing the DMRS pattern change with a certain periodicity (e.g., every fourth and eighth repetition onwards), such that the UE may only need to perform blind detection or search for the downlink DCI on those repetitions. The DCI overhead may only be associated with those repetitions. For example, with eight repetition, the DMRS pattern may only be allowed to change after four repetitions, so the blind detection may only be needed for the first transmission of the last four repetitions. An ability to indicate the preferred DMRS density dynamically or statically may be applicable to various use cases, including coverage enhancement scenarios (e.g., eMTC, NB-IOT) sidelink repetition, sidelink unlicensed (SL-U) (e.g., a multi-transmission time interval (multi-TTI) grant), and/or multiple transmissions from the same downlink grant with different transport blocks (instead of repetitions). The ability to indicate the preferred DMRS density dynamically or statically may provide various advantages, such as improved channel estimation, increased chances of successful decoding without waiting for all repetitions to complete (which saves UE power and improves latency), and/or optimized use of PDSCH/PUSCH resources and improved spectral efficiency.

As indicated above, FIG. 4 is provided as an example. Other examples may differ from what is described with regard to FIG. 4.

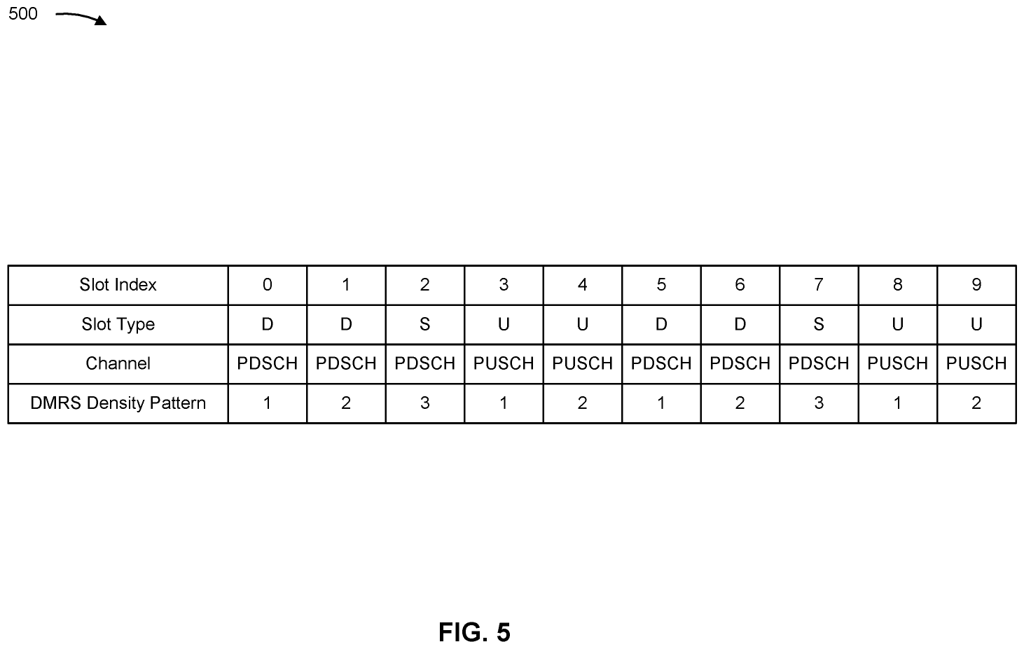

FIG. 5 is a diagram illustrating an example 500 associated with DMRS patterns having different DMRS densities, in accordance with the present disclosure.

As shown in FIG. 5, different DMRS density patterns may be configured for different slots. A number of configured DMRS density patterns may be defined (e.g., three possible DMRS density patterns), where a first DMRS density pattern (e.g., DMRS density pattern 1) may be associated with a most dense DMRS and a third DMRS density pattern (e.g., DMRS density pattern 3) may be associated with a least dense DMRS. Slot #0 may be associated with a downlink slot type and a PDSCH. Slot #0 may be a first slot of a transmission, and the first DMRS density pattern may be enabled. Slot #1 may be associated with a downlink slot type and a PDSCH. Slot #1 may be associated with the second DMRS density pattern (e.g., DMRS density pattern 2). Slot #2 may be associated with a special slot type and a PDSCH, such that slot #2 may be associated with a downlink. Slot #2 may be associated with the third DMRS density pattern. Slot #1 and slot #2 may be subsequent downlink slots, in which a less dense DMRS may be enabled based at least in part on a UE capability to achieve a steady state. Slot #3 may be associated with an uplink slot type and a PUSCH. Slot #3 may be associated with the first DMRS density pattern. Slot #3 may be a first uplink slot after a special slot (which functions as a downlink slot). While switching from a reception to a transmission, the UE may need time to settle down its phase in the first uplink slot after the special slot that functions as the downlink slot. Some phase drift may occur across different symbols in the first uplink slot. Thus, the first DMRS density pattern may be enabled in slot #3. Slot #4 may be associated with an uplink slot type and a PUSCH. Slot #4 may be associated with the second DMRS density pattern. Slot #4 may be a subsequent uplink slot that may be enabled with a less dense DMRS based at least in part on the UE capability to achieve the steady state.

In some aspects, slot #5 may be associated with a downlink slot type and a PDSCH. Slot #5 may be associated with the first DMRS density pattern. Slot #5 may be a first downlink slot after an uplink slot. While switching from a transmission to a reception, the UE may need time to settle down its phase in the first downlink slot after the uplink slot. Some phase drift may occur across different symbols in the first downlink slot. Thus, the first DMRS density pattern may be enabled in slot #5. Slot #6 may be associated with a downlink slot type and a PDSCH. Slot #6 may be associated with the second DMRS density pattern. Slot #7 may be associated with a special slot type and a PDSCH. Slot #7 may be associated with the third DMRS density pattern. Slot #6 and slot #7 may be subsequent downlink slots, in which a less dense DMRS may be enabled based at least in part on a UE capability to achieve a steady state. Slot #8 may be associated with an uplink slot type and a PUSCH. Slot #8 may be associated with the first DMRS density pattern, similar to slot #3. Slot #9 may be associated with an uplink slot type and a PUSCH. Slot #9 may be associated with the second DMRS density pattern, similar to slot #4.

As indicated above, FIG. 5 is provided as an example. Other examples may differ from what is described with regard to FIG. 5.

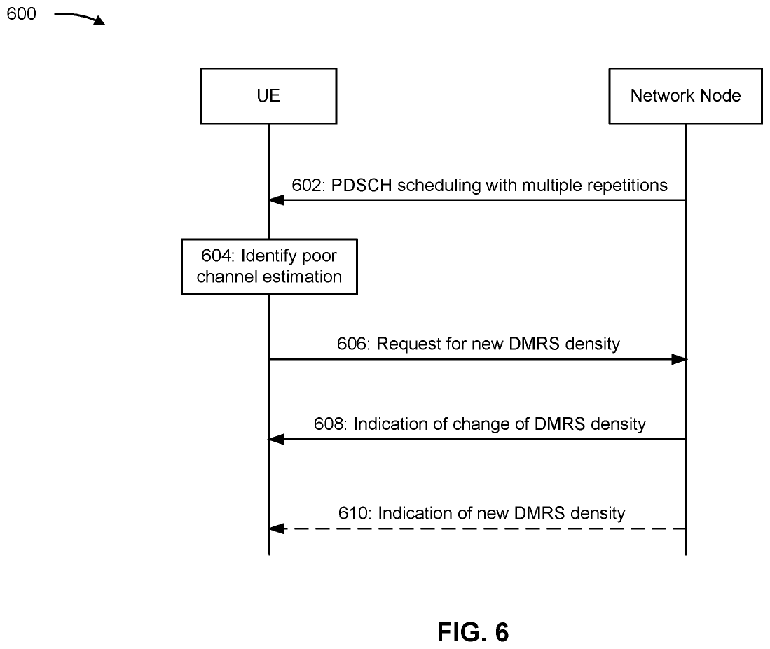

FIG. 6 is a diagram illustrating an example 600 associated with DMRS patterns having different DMRS densities, in accordance with the present disclosure. As shown in FIG. 6, example 600 includes communication between a UE (e.g., UE 120) and a network node (e.g., network node 110). In some aspects, the UE and the network node may be included in a wireless network, such as wireless network 100.

As shown by reference number 602, the UE may receive, from the network node, a PDSCH scheduling with multiple repetitions (e.g., X repetitions). The UE may be scheduled with PUCCH resources for providing interim HARQ feedback. A PDSCH decoding may fail at the UE after N repetitions, where N is less than X. As shown by reference number 604, the UE may identify a poor channel estimation based at least in part on predefined metrics. The predefined metrics may include an SNR, an RSRP measurement, an RSSI measurement, and/or a Doppler estimate. As shown by reference number 606, the UE may transmit, to the network node, a request for a new DMRS density (e.g., using two bits). The UE may transmit the request over a PUCCH, along with a HARQ feedback. The HARQ feedback may be a NACK, which may be based at least in part on the PDSCH decoding failure. As shown by reference number 608, the network node may transmit, to the UE, an indication of a change of DMRS density, which may be based at least in part on the request received from the UE. The network node may signal the change of DMRS density using a downlink piggyback DCI, which may be rate matched around data but may not affect a payload. Alternatively, the network node may signal the change of DMRS density using different DMRS sequences. The network node may use the different DMRS sequences to signal different DMRS patterns. As shown by reference number 610, the network node may indicate, to the UE, an indication of a new DMRS density. The network node may detect a need to change a current DMRS density over a PUSCH, and the network node may indicate the new DMRS density to the UE over an uplink DCI.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120) performs operations associated with DMRS patterns having different DMRS densities.

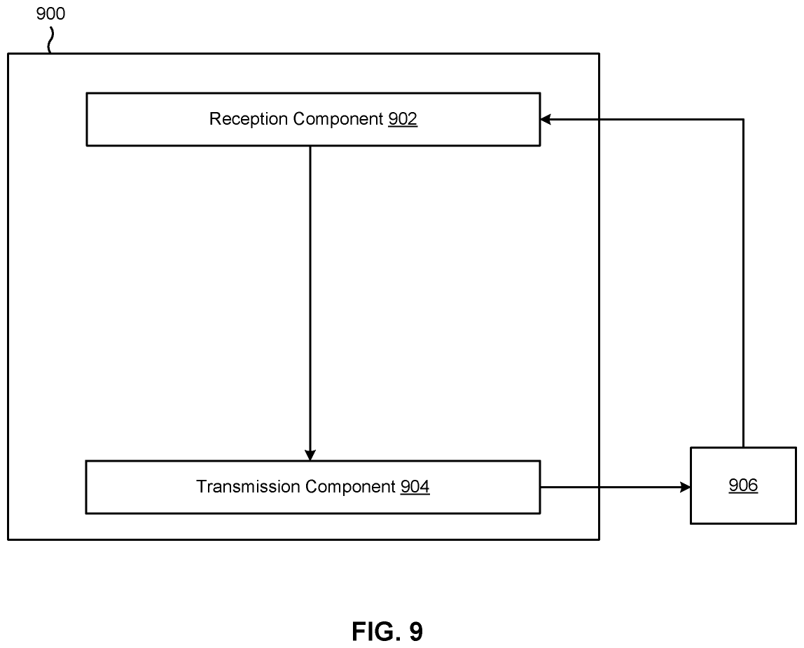

As shown in FIG. 7, in some aspects, process 700 may include transmitting, to a network node, an uplink transmission in an uplink slot, the uplink slot being associated with a first DMRS pattern having a first DMRS density (block 710). For example, the UE (e.g., using transmission component 904, depicted in FIG. 9) may transmit, to a network node, an uplink transmission in an uplink slot, the uplink slot being associated with a first DMRS pattern having a first DMRS density, as described above.

As further shown in FIG. 7, in some aspects, process 700 may include receiving, from the network node, a downlink transmission in a downlink slot, the downlink slot being associated with a second DMRS pattern having a second DMRS density (block 720). For example, the UE (e.g., using reception component 902, depicted in FIG. 9) may receive, from the network node, a downlink transmission in a downlink slot, the downlink slot being associated with a second DMRS pattern having a second DMRS density, as described above.

Process 700 may include additional aspects, such as any single aspect or any combination of aspects described below and/or in connection with one or more other processes described elsewhere herein.

In a first aspect, the downlink slot occurs after the uplink slot, and the second DMRS density is higher than the first DMRS density.

In a second aspect, alone or in combination with the first aspect, the uplink slot occurs after the downlink slot, and the first DMRS density is higher than the second DMRS density.

In a third aspect, alone or in combination with one or more of the first and second aspects, process 700 includes transmitting, to the network node, an indication of a DMRS pattern index, wherein the DMRS pattern index is selected from a list of DMRS pattern indexes.

In a fourth aspect, alone or in combination with one or more of the first through third aspects, process 700 includes transmitting, to the network node, an indication of a phase discontinuity associated with the downlink slot or the uplink slot, and receiving, from the network node and based at least in part on the indication, a configuration of multiple DMRS patterns with different additional positions and slot offsets, wherein the multiple DMRS patterns include the first DMRS pattern and the second DMRS pattern.

In a fifth aspect, alone or in combination with one or more of the first through fourth aspects, a special slot is associated with a third DMRS pattern having a third DMRS density, and the third DMRS pattern is based at least in part on one or more of a downlink-uplink switching defined by a semi-static TDD pattern, an SFI, or a dynamic grant.

In a sixth aspect, alone or in combination with one or more of the first through fifth aspects, different DMRS patterns having different DMRS densities are defined for one or more of different frequency ranges, different bands, different SCSs, or different MCSs.

In a seventh aspect, alone or in combination with one or more of the first through sixth aspects, the downlink transmission is one of multiple repetitions associated with a multi-slot and repetition-based transmission.

In an eighth aspect, alone or in combination with one or more of the first through seventh aspects, process 700 includes transmitting, to the network node, a request for a preferred DMRS pattern having a preferred DMRS density during the multi-slot and repetition-based transmission, wherein the request is based at least in part on a metric associated with the multi-slot and repetition-based transmission, and receiving, from the network node and based at least in part on the request being granted, an indication of a new DMRS pattern having a new DMRS density, wherein the indication is received downlink control information (DCI) via a PDCCH, and wherein the PDCCH is rate matched on physical downlink shared channel (PDSCH) resources intended for the UE.

In a ninth aspect, alone or in combination with one or more of the first through eighth aspects, process 700 includes receiving, from the network node, an indication of a new DMRS pattern having a new DMRS density, wherein the indication is based at least in part on a metric associated with the multi-slot and repetition-based transmission, wherein the new DMRS pattern having the new DMRS density is indicated via a mapping to a random sequence of a plurality of random sequences, wherein a PDSCH DMRS or data signal is scrambled with the random sequence, wherein multiple hypotheses of de-scrambling are based at least in part on the plurality of random sequences and a blind detection is performed after a number of repetitions to reduce a blind detection overhead, wherein the indication indicates a downlink slot offset and a number of slots for which the new DMRS pattern having the new DMRS density is valid, and wherein the indication is received as a static configuration over RRC signaling or the indication is received dynamically over a PDSCH MAC-CE.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 110) performs operations associated with DMRS patterns having different DMRS densities.

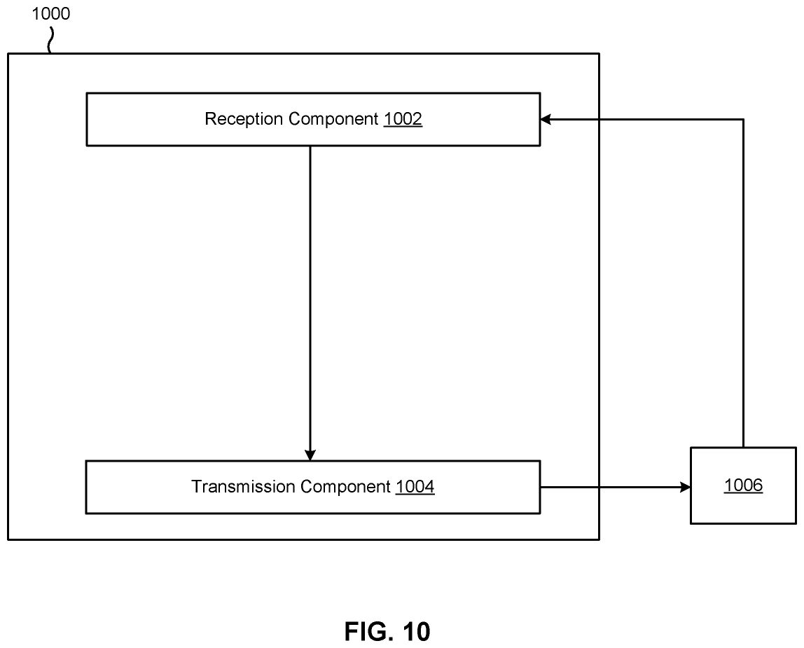

As shown in FIG. 8, in some aspects, process 800 may include receiving, from a UE, an uplink transmission in an uplink slot, the uplink slot being associated with a first DMRS pattern having a first DMRS density (block 810). For example, the network node (e.g., using reception component 1002, depicted in FIG. 10) may receive, from a UE, an uplink transmission in an uplink slot, the uplink slot being associated with a first DMRS pattern having a first DMRS density, as described above.

As further shown in FIG. 8, in some aspects, process 800 may include transmitting, to the UE, a downlink transmission in a downlink slot that occurs after the uplink slot, the downlink slot being associated with a second DMRS pattern having a second DMRS density (block 820). For example, the network node (e.g., using transmission component 1004, depicted in FIG. 10) may transmit, to the UE, a downlink transmission in a downlink slot that occurs after the uplink slot, the downlink slot being associated with a second DMRS pattern having a second DMRS density, as described above.

Process 800 may include additional aspects, such as any single aspect or any combination of aspects described below and/or in connection with one or more other processes described elsewhere herein.

In a first aspect, the downlink slot occurs after the uplink slot, and the second DMRS density is higher than the first DMRS density.

In a second aspect, alone or in combination with the first aspect, the uplink slot occurs after the downlink slot, and the first DMRS density is higher than the second DMRS density.

In a third aspect, alone or in combination with one or more of the first and second aspects, process 800 includes receiving, from the UE, an indication of a DMRS pattern index, wherein the DMRS pattern index is selected from a list of DMRS pattern indexes.

In a fourth aspect, alone or in combination with one or more of the first through third aspects, process 800 includes receiving, from the UE, an indication of a phase discontinuity associated with the downlink slot or the uplink slot, and transmitting, to the UE and based at least in part on the indication, a configuration of multiple DMRS patterns with different additional positions and slot offsets, wherein the multiple DMRS patterns include the first DMRS pattern and the second DMRS pattern.

In a fifth aspect, alone or in combination with one or more of the first through fourth aspects, a special slot is associated with a third DMRS pattern having a third DMRS density, and the third DMRS pattern is based at least in part on one or more of a downlink-uplink switching defined by a semi-static TDD pattern, an SFI, or a dynamic grant.

In a sixth aspect, alone or in combination with one or more of the first through fifth aspects, different DMRS patterns having different DMRS densities are defined for one or more of different frequency ranges, different bands, different SCSs, or different MCSs.

In a seventh aspect, alone or in combination with one or more of the first through sixth aspects, the downlink transmission is one of multiple repetitions associated with a multi-slot and repetition-based transmission.

In an eighth aspect, alone or in combination with one or more of the first through seventh aspects, process 800 includes receiving, from the UE, a request for a preferred DMRS pattern having a preferred DMRS density during the multi-slot and repetition-based transmission, wherein the request is based at least in part on a metric associated with the multi-slot and repetition-based transmission, and transmitting, to the UE and based at least in part on the request being granted, an indication of a new DMRS pattern having a new DMRS density, wherein the indication is transmitted in downlink control information (DCI) via a physical downlink control channel (PDCCH), and wherein the PDCCH is rate matched on physical downlink shared channel (PDSCH) resources intended for the UE.

In a ninth aspect, alone or in combination with one or more of the first through eighth aspects, process 800 includes transmitting, to the UE, an indication of a new DMRS pattern having a new DMRS density, wherein the indication is based at least in part on a metric associated with the multi-slot and repetition-based transmission, wherein the new DMRS pattern having the new DMRS density is indicated via a mapping to a random sequence of a plurality of random sequences, wherein a PDSCH DMRS or data signal is scrambled with the random sequence, wherein multiple hypotheses of de-scrambling are based at least in part on the plurality of random sequences and a blind detection is performed after a number of repetitions to reduce a blind detection overhead, wherein the indication indicates a downlink slot offset and a number of slots for which the new DMRS pattern having the new DMRS density is valid, and wherein the indication is received as a static configuration over RRC signaling or the indication is received dynamically over a PDSCH MAC-CE.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904.

In some aspects, the apparatus 900 may be configured to perform one or more operations described herein in connection with FIGS. 4-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The transmission component 904 may transmit, to a network node, an uplink transmission in an uplink slot, the uplink slot being associated with a first DMRS pattern having a first DMRS density. The reception component 902 may receive, from the network node, a downlink transmission in a downlink slot, the downlink slot being associated with a second DMRS pattern having a second DMRS density.

The transmission component 904 may transmit, to the network node, an indication of a DMRS pattern index, wherein the DMRS pattern index is selected from a list of DMRS pattern indexes. The transmission component 904 may transmit, to the network node, an indication of a phase discontinuity associated with the downlink slot or the uplink slot. The reception component 902 may receive, from the network node and based at least in part on the indication, a configuration of multiple DMRS patterns with different additional positions and slot offsets, wherein the multiple DMRS patterns include the first DMRS pattern and the second DMRS pattern.

The transmission component 904 may transmit, to the network node, a request for a preferred DMRS pattern having a preferred DMRS density during the multi-slot and repetition-based transmission, wherein the request is based at least in part on a metric associated with the multi-slot and repetition-based transmission. The reception component 902 may receive, from the network node and based at least in part on the request being granted, an indication of a new DMRS pattern having a new DMRS density, wherein the indication is received downlink control information (DCI) via a physical downlink control channel (PDCCH), and wherein the PDCCH is rate matched on physical downlink shared channel (PDSCH) resources intended for the UE. The reception component 902 may receive, from the network node, an indication of a new DMRS pattern having a new DMRS density, wherein the indication is based at least in part on a metric associated with the multi-slot and repetition-based transmission, wherein the new DMRS pattern having the new DMRS density is indicated via a mapping to a random sequence of a plurality of random sequences, wherein a PDSCH DMRS or data signal is scrambled with the random sequence, wherein multiple hypotheses of de-scrambling are based at least in part on the plurality of random sequences and a blind detection is performed after a number of repetitions to reduce a blind detection overhead, wherein the indication indicates a downlink slot offset and a number of slots for which the new DMRS pattern having the new DMRS density is valid, and wherein the indication is received as a static configuration over RRC signaling or the indication is received dynamically over a PDSCH MAC-CE.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004.

In some aspects, the apparatus 1000 may be configured to perform one or more operations described herein in connection with FIGS. 4-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The reception component 1002 may receive, from a UE, an uplink transmission in an uplink slot, the uplink slot being associated with a first DMRS pattern having a first DMRS density. The transmission component 1004 may transmit, to the UE, a downlink transmission in a downlink slot that occurs after the uplink slot, the downlink slot being associated with a second DMRS pattern having a second DMRS density.

The reception component 1002 may receive, from the UE, an indication of a DMRS pattern index, wherein the DMRS pattern index is selected from a list of DMRS pattern indexes. The reception component 1002 may receive, from the UE, an indication of a phase discontinuity associated with the downlink slot or the uplink slot. The transmission component 1004 may transmit, to the UE and based at least in part on the indication, a configuration of multiple DMRS patterns with different additional positions and slot offsets, wherein the multiple DMRS patterns include the first DMRS pattern and the second DMRS pattern.

The reception component 1002 may receive, from the UE, a request for a preferred DMRS pattern having a preferred DMRS density during the multi-slot and repetition-based transmission, wherein the request is based at least in part on a metric associated with the multi-slot and repetition-based transmission. The transmission component 1004 may transmit, to the UE and based at least in part on the request being granted, an indication of a new DMRS pattern having a new DMRS density, wherein the indication is transmitted in downlink control information (DCI) via a physical downlink control channel (PDCCH), and wherein the PDCCH is rate matched on physical downlink shared channel (PDSCH) resources intended for the UE. The transmission component 1004 may transmit, to the UE, an indication of a new DMRS pattern having a new DMRS density, wherein the indication is based at least in part on a metric associated with the multi-slot and repetition-based transmission, wherein the new DMRS pattern having the new DMRS density is indicated via a mapping to a random sequence of a plurality of random sequences, wherein a PDSCH DMRS or data signal is scrambled with the random sequence, wherein multiple hypotheses of de-scrambling are based at least in part on the plurality of random sequences and a blind detection is performed after a number of repetitions to reduce a blind detection overhead, wherein the indication indicates a downlink slot offset and a number of slots for which the new DMRS pattern having the new DMRS density is valid, and wherein the indication is received as a static configuration over RRC signaling or the indication is received dynamically over a PDSCH MAC-CE.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: transmitting, to a network node, an uplink transmission in an uplink slot, the uplink slot being associated with a first demodulation reference signal (DMRS) pattern having a first DMRS density; and receiving, from the network node, a downlink transmission in a downlink slot, the downlink slot being associated with a second DMRS pattern having a second DMRS density.

Aspect 2: The method of Aspect 1, wherein the downlink slot occurs after the uplink slot, and wherein the second DMRS density is higher than the first DMRS density.

Aspect 3: The method of any of Aspects 1-2, wherein the uplink slot occurs after the downlink slot, and wherein the first DMRS density is higher than the second DMRS density.

Aspect 4: The method of any of Aspects 1-3, further comprising: transmitting, to the network node, an indication of a DMRS pattern index, wherein the DMRS pattern index is selected from a list of DMRS pattern indexes.

Aspect 5: The method of any of Aspects 1-4, further comprising: transmitting, to the network node, an indication of a phase discontinuity associated with the downlink slot or the uplink slot; and receiving, from the network node and based at least in part on the indication, a configuration of multiple DMRS patterns with different additional positions and slot offsets, wherein the multiple DMRS patterns include the first DMRS pattern and the second DMRS pattern.

Aspect 6: The method of any of Aspects 1-5, wherein a special slot is associated with a third DMRS pattern having a third DMRS density, and wherein the third DMRS pattern is based at least in part on one or more of: a downlink-uplink switching defined by a semi-static time division duplexing pattern, a slot format indication, or a dynamic grant.

Aspect 7: The method of any of Aspects 1-6, wherein different DMRS patterns having different DMRS densities are defined for one or more of: different frequency ranges, different bands, different subcarrier spacings, or different modulation and coding schemes.

Aspect 8: The method of any of Aspects 1-7, wherein the downlink transmission is one of multiple repetitions associated with a multi-slot and repetition-based transmission.

Aspect 9: The method of Aspect 8, further comprising: transmitting, to the network node, a request for a preferred DMRS pattern having a preferred DMRS density during the multi-slot and repetition-based transmission, wherein the request is based at least in part on a metric associated with the multi-slot and repetition-based transmission; and receiving, from the network node, an indication that the request is granted.

Aspect 10: The method of Aspect 8, further comprising: receiving, from the network node, an indication of a new DMRS pattern having a new DMRS density, wherein the indication is based at least in part on a metric associated with the multi-slot and repetition-based transmission, wherein the new DMRS pattern having the new DMRS density is indicated via a mapping to a random sequence of a plurality of random sequences, wherein a physical downlink shared channel (PDSCH) DMRS or data signal is scrambled with the random sequence, wherein multiple hypotheses of de-scrambling are based at least in part on the plurality of random sequences and a blind detection is performed after a number of repetitions to reduce a blind detection overhead, wherein the indication indicates a downlink slot offset and a number of slots for which the new DMRS pattern having the new DMRS density is valid, and wherein the indication is received as a static configuration over radio resource control (RRC) signaling or the indication is received dynamically over a PDSCH medium access control control element (MAC-CE).

Aspect 11: A method of wireless communication performed by a network node, comprising: receiving, from a user equipment (UE), an uplink transmission in an uplink slot, the uplink slot being associated with a first demodulation reference signal (DMRS) pattern having a first DMRS density; and transmitting, to the UE, a downlink transmission in a downlink slot that occurs after the uplink slot, the downlink slot being associated with a second DMRS pattern having a second DMRS density.

Aspect 12: The method of Aspect 11, wherein the downlink slot occurs after the uplink slot, and wherein the second DMRS density is higher than the first DMRS density.

Aspect 13: The method of any of Aspects 11-12, wherein the uplink slot occurs after the downlink slot, and wherein the first DMRS density is higher than the second DMRS density.

Aspect 14: The method of any of Aspects 11-13, further comprising: receiving, from the UE, an indication of a DMRS pattern index, wherein the DMRS pattern index is selected from a list of DMRS pattern indexes.

Aspect 15: The method of any of Aspects 11-14, further comprising: receiving, from the UE, an indication of a phase discontinuity associated with the downlink slot or the uplink slot; and transmitting, to the UE and based at least in part on the indication, a configuration of multiple DMRS patterns with different additional positions and slot offsets, wherein the multiple DMRS patterns include the first DMRS pattern and the second DMRS pattern.

Aspect 16: The method of any of Aspects 11-15, wherein a special slot is associated with a third DMRS pattern having a third DMRS density, and wherein the third DMRS pattern is based at least in part on one or more of: a downlink-uplink switching defined by a semi-static time division duplexing pattern, a slot format indication, or a dynamic grant.

Aspect 17: The method of any of Aspects 11-16, wherein different DMRS patterns having different DMRS densities are defined for one or more of: different frequency ranges, different bands, different subcarrier spacings, or different modulation and coding schemes.

Aspect 18: The method of any of Aspects 11-17, wherein the downlink transmission is one of multiple repetitions associated with a multi-slot and repetition-based transmission.

Aspect 19: The method of Aspect 18, further comprising: receiving, from the UE, a request for a preferred DMRS pattern having a preferred DMRS density during the multi-slot and repetition-based transmission, wherein the request is based at least in part on a metric associated with the multi-slot and repetition-based transmission; and transmitting, to the UE, an indication that the request is granted.

Aspect 20: The method of Aspect 18, further comprising: transmitting, to the UE, an indication of a new DMRS pattern having a new DMRS density, wherein the indication is based at least in part on a metric associated with the multi-slot and repetition-based transmission, wherein the new DMRS pattern having the new DMRS density is indicated via a mapping to a random sequence of a plurality of random sequences, wherein a physical downlink shared channel (PDSCH) DMRS or data signal is scrambled with the random sequence, wherein multiple hypotheses of de-scrambling are based at least in part on the plurality of random sequences and a blind detection is performed after a number of repetitions to reduce a blind detection overhead, wherein the indication indicates a downlink slot offset and a number of slots for which the new DMRS pattern having the new DMRS density is valid, and wherein the indication is received as a static configuration over radio resource control (RRC) signaling or the indication is received dynamically over a PDSCH medium access control control element (MAC-CE).

Aspect 21: An apparatus for wireless communication at a device, comprising a processor; memory coupled with the processor; and instructions stored in the memory and executable by the processor to cause the apparatus to perform the method of one or more of Aspects 1-10.

Aspect 22: A device for wireless communication, comprising a memory and one or more processors coupled to the memory, the one or more processors configured to perform the method of one or more of Aspects 1-10.

Aspect 23: An apparatus for wireless communication, comprising at least one means for performing the method of one or more of Aspects 1-10.

Aspect 24: A non-transitory computer-readable medium storing code for wireless communication, the code comprising instructions executable by a processor to perform the method of one or more of Aspects 1-10.

Aspect 25: A non-transitory computer-readable medium storing a set of instructions for wireless communication, the set of instructions comprising one or more instructions that, when executed by one or more processors of a device, cause the device to perform the method of one or more of Aspects 1-10.

Aspect 26: An apparatus for wireless communication at a device, comprising a processor; memory coupled with the processor; and instructions stored in the memory and executable by the processor to cause the apparatus to perform the method of one or more of Aspects 11-20.

Aspect 27: A device for wireless communication, comprising a memory and one or more processors coupled to the memory, the one or more processors configured to perform the method of one or more of Aspects 11-20.

Aspect 28: An apparatus for wireless communication, comprising at least one means for performing the method of one or more of Aspects 11-20.

Aspect 29: A non-transitory computer-readable medium storing code for wireless communication, the code comprising instructions executable by a processor to perform the method of one or more of Aspects 11-20.

Aspect 30: A non-transitory computer-readable medium storing a set of instructions for wireless communication, the set of instructions comprising one or more instructions that, when executed by one or more processors of a device, cause the device to perform the method of one or more of Aspects 11-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. An apparatus for wireless communication at a user equipment (UE), comprising:
a memory; and
one or more processors, coupled to the memory, configured to:
transmit, to a network node, an uplink transmission in an uplink slot, the uplink slot being associated with a first demodulation reference signal (DMRS) pattern having a first DMRS density; and
receive, from the network node, a downlink transmission in a downlink slot, the downlink slot being associated with a second DMRS pattern having a second DMRS density.

2. The apparatus of claim 1, wherein the downlink slot occurs after the uplink slot, and wherein the second DMRS density is higher than the first DMRS density.

3. The apparatus of claim 1, wherein the uplink slot occurs after the downlink slot, and wherein the first DMRS density is higher than the second DMRS density.

4. The apparatus of claim 1, wherein the one or more processors are further configured to:
transmit, to the network node, an indication of a DMRS pattern index, wherein the DMRS pattern index is selected from a list of DMRS pattern indexes.

5. The apparatus of claim 1, wherein the one or more processors are further configured to:
transmit, to the network node, an indication of a phase discontinuity associated with the downlink slot or the uplink slot; and
receive, from the network node and based at least in part on the indication, a configuration of multiple DMRS patterns with different additional positions and slot offsets, wherein the multiple DMRS patterns include the first DMRS pattern and the second DMRS pattern.

6. The apparatus of claim 1, wherein a special slot is associated with a third DMRS pattern having a third DMRS density, and wherein the third DMRS pattern is based at least in part on one or more of: a downlink-uplink switching defined by a semi-static time division duplexing pattern, a slot format indication, or a dynamic grant.

7. The apparatus of claim 1, wherein different DMRS patterns having different DMRS densities are defined for one or more of: different frequency ranges, different bands, different subcarrier spacings, or different modulation and coding schemes.

8. The apparatus of claim 1, wherein the downlink transmission is one of multiple repetitions associated with a multi-slot and repetition-based transmission.

9. The apparatus of claim 8, wherein the one or more processors are further configured to:
transmit, to the network node, a request for a preferred DMRS pattern having a preferred DMRS density during the multi-slot and repetition-based transmission, wherein the request is based at least in part on a metric associated with the multi-slot and repetition-based transmission; and
receive, from the network node and based at least in part on the request being granted, an indication of a new DMRS pattern having a new DMRS density, wherein the indication is received in downlink control information (DCI) via a physical downlink control channel (PDCCH), and wherein the PDCCH is rate matched on physical downlink shared channel (PDSCH) resources intended for the UE.

10. The apparatus of claim 8, wherein the one or more processors are further configured to:
receive, from the network node, an indication of a new DMRS pattern having a new DMRS density, wherein the indication is based at least in part on a metric associated with the multi-slot and repetition-based transmission, wherein the new DMRS pattern having the new DMRS density is indicated via a mapping to a random sequence of a plurality of random sequences, wherein a physical downlink shared channel (PDSCH) DMRS or data signal is scrambled with the random sequence, wherein multiple hypotheses of de-scrambling are based at least in part on the plurality of random sequences and a blind detection is performed after a number of repetitions to reduce a blind detection overhead, wherein the indication indicates a downlink slot offset and a number of slots for which the new DMRS pattern having the new DMRS density is valid, and wherein the indication is received as a static configuration over radio resource control (RRC) signaling or the indication is received dynamically over a PDSCH medium access control control element (MAC-CE).

11. An apparatus for wireless communication at a network node, comprising:
a memory; and
one or more processors, coupled to the memory, configured to:
receive, from a user equipment (UE), an uplink transmission in an uplink slot, the uplink slot being associated with a first demodulation reference signal (DMRS) pattern having a first DMRS density; and
transmit, to the UE, a downlink transmission in a downlink slot, the downlink slot being associated with a second DMRS pattern having a second DMRS density.

12. The apparatus of claim 11, wherein the downlink slot occurs after the uplink slot, and wherein the second DMRS density is higher than the first DMRS density.

13. The apparatus of claim 11, wherein the uplink slot occurs after the downlink slot, and wherein the first DMRS density is higher than the second DMRS density.

14. The apparatus of claim 11, wherein the one or more processors are further configured to:
receive, from the UE, an indication of a DMRS pattern index, wherein the DMRS pattern index is selected from a list of DMRS pattern indexes.

15. The apparatus of claim 11, wherein the one or more processors are further configured to:
receive, from the UE, an indication of a phase discontinuity associated with the downlink slot or the uplink slot; and
transmit, to the UE and based at least in part on the indication, a configuration of multiple DMRS patterns with different additional positions and slot offsets, wherein the multiple DMRS patterns include the first DMRS pattern and the second DMRS pattern.

16. The apparatus of claim 11, wherein a special slot is associated with a third DMRS pattern having a third DMRS density, and wherein the third DMRS pattern is based at least in part on one or more of: a downlink-uplink switching defined by a semi-static time division duplexing pattern, a slot format indication, or a dynamic grant.

17. The apparatus of claim 11, wherein different DMRS patterns having different DMRS densities are defined for one or more of: different frequency ranges, different bands, different subcarrier spacings, or different modulation and coding schemes.

18. The apparatus of claim 11, wherein the downlink transmission is one of multiple repetitions associated with a multi-slot and repetition-based transmission.

19. The apparatus of claim 18, wherein the one or more processors are further configured to:
receive, from the UE, a request for a preferred DMRS pattern having a preferred DMRS density during the multi-slot and repetition-based transmission, wherein the request is based at least in part on a metric associated with the multi-slot and repetition-based transmission; and
transmit, to the UE and based at least in part on the request being granted, an indication of a new DMRS pattern having a new DMRS density, wherein the indication is transmitted in downlink control information (DCI) via a physical downlink control channel (PDCCH), and wherein the PDCCH is rate matched on physical downlink shared channel (PDSCH) resources intended for the UE.

20. The apparatus of claim 18, wherein the one or more processors are further configured to:
transmit, to the UE, an indication of a new DMRS pattern having a new DMRS density, wherein the indication is based at least in part on a metric associated with the multi-slot and repetition-based transmission, wherein the new DMRS pattern having the new DMRS density is indicated via a mapping to a random sequence of a plurality of random sequences, wherein a physical downlink shared channel (PDSCH) DMRS or data signal is scrambled with the random sequence, wherein multiple hypotheses of de-scrambling are based at least in part on the plurality of random sequences and a blind detection is performed after a number of repetitions to reduce a blind detection overhead, wherein the indication indicates a downlink slot offset and a number of slots for which the new DMRS pattern having the new DMRS density is valid, and wherein the indication is received as a static configuration over radio resource control (RRC) signaling or the indication is received dynamically over a PDSCH medium access control control element (MAC-CE).

21. A method of wireless communication performed by a user equipment (UE), comprising:
transmitting, to a network node, an uplink transmission in an uplink slot, the uplink slot being associated with a first demodulation reference signal (DMRS) pattern having a first DMRS density; and
receiving, from the network node, a downlink transmission in a downlink slot, the downlink slot being associated with a second DMRS pattern having a second DMRS density.

22. The method of claim 21, wherein:
the downlink slot occurs after the uplink slot, and wherein the second DMRS density is higher than the first DMRS density; or
the uplink slot occurs after the downlink slot, and wherein the first DMRS density is higher than the second DMRS density.

23. The method of claim 21, further comprising:
transmitting, to the network node, an indication of a DMRS pattern index, wherein the DMRS pattern index is selected from a list of DMRS pattern indexes.

24. The method of claim 21, further comprising:
transmitting, to the network node, an indication of a phase discontinuity associated with the downlink slot or the uplink slot; and
receiving, from the network node and based at least in part on the indication, a configuration of multiple DMRS patterns with different additional positions and slot offsets, wherein the multiple DMRS patterns include the first DMRS pattern and the second DMRS pattern.

25. The method of claim 21, wherein the downlink transmission is one of multiple repetitions associated with a multi-slot and repetition-based transmission.

26. The method of claim 25, further comprising:
transmitting, to the network node, a request for a preferred DMRS pattern having a preferred DMRS density during the multi-slot and repetition-based transmission, wherein the request is based at least in part on a metric associated with the multi-slot and repetition-based transmission; and
receiving, from the network node and based at least in part on the request being granted, an indication of a new DMRS pattern having a new DMRS density, wherein the indication is received downlink control information (DCI) via a physical downlink control channel (PDCCH), and wherein the PDCCH is rate matched on physical downlink shared channel (PDSCH) resources intended for the UE.

27. The method of claim 25, further comprising:
receiving, from the network node, an indication of a new DMRS pattern having a new DMRS density, wherein the indication is based at least in part on a metric associated with the multi-slot and repetition-based transmission, wherein the new DMRS pattern having the new DMRS density is indicated via a mapping to a random sequence of a plurality of random sequences, wherein a physical downlink shared channel (PDSCH) DMRS or data signal is scrambled with the random sequence, wherein multiple hypotheses of de-scrambling are based at least in part on the plurality of random sequences and a blind detection is performed after a number of repetitions to reduce a blind detection overhead, wherein the indication indicates a downlink slot offset and a number of slots for which the new DMRS pattern having the new DMRS density is valid, and wherein the indication is received as a static configuration over radio resource control (RRC) signaling or the indication is received dynamically over a PDSCH medium access control control element (MAC-CE).

28. A method of wireless communication performed by a network node, comprising:
receiving, from a user equipment (UE), an uplink transmission in an uplink slot, the uplink slot being associated with a first demodulation reference signal (DMRS) pattern having a first DMRS density; and
transmitting, to the UE, a downlink transmission in a downlink slot that occurs after the uplink slot, the downlink slot being associated with a second DMRS pattern having a second DMRS density.

29. The method of claim 28, wherein:
the downlink slot occurs after the uplink slot, and wherein the second DMRS density is higher than the first DMRS density; or
the uplink slot occurs after the downlink slot, and wherein the first DMRS density is higher than the second DMRS density.

30. The method of claim 28, wherein the downlink transmission is one of multiple repetitions associated with a multi-slot and repetition-based transmission.
